(19) United States
(12) Patent Application Publication
(10) Pub. No.: US 2007/0022307 A1
(43) Pub. Date: Jan. 25, 2007

(54) Access protection method for digital data carriers, in particular DVDs

(76) Inventor: Tilo Ferrari, Hamburg (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/195,343

(22) Filed: Aug. 2, 2005

(30) Foreign Application Priority Data
Jul. 19, 2005 (DE) 10 20050034 154.3

(51) Int. Cl. H04L 9/32; G06F 12/14; G06F 17/30; G06F 7/04; G06F 11/30; G06K 9/00; H03M 1/68; H04K 1/00; H04L 9/00; H04N 7/16; H04N 7/167

(52) U.S. Cl. 713/193; 726/27; 380/232

(57) ABSTRACT

Method for safeguarding access to digital data carrier, in particular DVD or another data carrier based on DVD standard. Playback data on these data carriers includes pre-commands or post-commands before or after the playback data. The user may be prompted, before each playback, to input a key through pre-command or post-command. This key may be obtained or purchased via a support centre. To prevent the same key from being used for each playback operation, the keys are preferably in pairs, one part determined automatically by processing the pre-commands and post-commands and the other part obtained from the support centre. Prior to each playback operation the key or pair of keys is verified after inputting the other part of the pair of keys. If key verification is negative, data playback is cancelled. If key verification is positive, the data is played back after being released for playback.

This patent refers to an access protection method for permitting playback of data carriers, in particular DVDs, only on the basis of a release code.

### TECHNICAL FIELD

The safeguarding of digital data carriers such as DVDs or subsequent generations of DVDs using a corresponding descriptive language requires access protection methods in order to avoid unauthorised access to the data carrier or to information stored on the data carrier.

Thus playback and payment methods exist which contain an access safeguarding mechanism stored on the respective DVD, which mechanism protects the DVD contents against unauthorised access.

Some of the playback and payment methods are suitable for use as so-called pay-per-view playback and payment methods for DVDs. With such a method paying for the DVD contents (e.g. films, music) is typically effected separately each time the DVD contents are accessed.

In the following this recorded payment and playback method is called “offline pay-per-view method” (abbreviated to offlinePPV DVD or PPV DVD). The offline pay-per-view method is different from the online pay-per-view method—the conditional access-based payment and playback method, the standard playback and payment method and the serialised playback and payment method.

The online pay-per-view method is conditional upon online access to a central encoding and access verification system. This may be carried out via an internet connection or a telephone modem connection. The central encoding and access verification system decides on the DVD's playback requests and is responsible for executing the payment operation.

An alternative is the access via so-called conditional access systems. These are encoding systems which are stored on an individualised or serialised hardware unit (e.g. card and chip-based access verifications systems). With this method a check is carried using the hardware key as to whether the playback unit's playback request can be granted or not.

The standard playback and payment method grants the right to the buyer of a DVD to play back the contents stored on the DVD as many times as he wants to. As a rule, payment is effected, when the DVD is passed to the buyer.

With the serialised playback and payment method playback of the DVD contents is linked to a serial number which is used as identification of a copy of the DVD. With the serialised playback and payment method the playback operation is started only when a serial number is entered which matches the serial number stored on the respective DVD copy.

### SUMMARY OF THE INVENTION

It is the requirement of the invention to provide a method and data carrier, where access to the data is subject to a restriction.

The requirement is met by the features of the independent claims, wherein the subclaims represent preferred embodiments.

In detail, this is a method for safeguarding access to a digital data carrier, in particular a DVD or other data carrier of a format similar to a DVD. It should be understood that other data carriers such as Blue Ray or VCD structured in a similar way also fall into the category of these data carriers. These data carriers, together with the playback data, must have pre-commands or post-commands provided before and after the playback data.

The method comprises a number of steps. At the start, a key is read in by a pre-command or post-command via an input interface and then evaluated. This key is generally obtained by the user from a service centre (for instance by telephone). So as to avoid using the same key an infinite number of times, a pair of keys is preferably used, one part of which is automatically determined by the reading device or by the information on the data carrier (algorithm or plurality of encoded pairs of keys). Thereupon the key is verified and released by one or by a set of pre-commands or post-commands, before the DVD contents can be accessed for playback.

If the result of verifying the key is negative, playback of the data is cancelled. If the result of checking the key is positive, playback of the DVD contents proceeds. This prevents the user from skipping parts of the DVD contents (e.g. chapters) or starting playback of the DVD contents at any given position. The DVD has a plurality of areas integrated with a pre-command or a post-command, in order to ensure that cancellation is performed on a chapter-by-chapter-basis. As a rule, ejection of the DVD leads to cancellation.

When a pair of keys is used, which is stored on the data carrier in a potentially large number, preferably encoded, and randomly selected, or which is automatically determined by an algorithm in a deterministic form, one part of the pair of keys is displayed prompting the user to enter the other part. A service centre which e.g. can be contacted by telephone, or a support officer is capable of ascertaining this second key on the basis of the first key making the pair of keys complete.

After the user has been notified by the service centre or support officer of the second part of the key and has entered the second part via the input device (e.g. the remote control of a TV device), the entire key is checked for a match through the pre-commands or post-commands. The pair of keys is then placed temporarily into a suitable storage buffer for future checks using a pre-command or post-command.

If the recording conforms to the DVD standard, a DVD dummy PGC (program chain) is used which contains a set or a plurality of pre-commands and/or a set of post-commands for ascertaining the pair of keys. A part of the pre-commands calculates the pair of keys according to the above described method. A part of the pre-commands displays one part of the pair of keys on the screen and prompts for input of the second part of the pair of keys, which can be effected, for instance, via the remote control of the TV device. With this arrangement the second half of the pair of keys has to be obtained via a service centre or a support officer.

A part of the post-commands reads in the second part of the pair of keys displayed on the screen and verifies the pair of keys in order to store it in the key store, provided the two parts match, otherwise the operation is cancelled.

After successfully inputting the second key of the pair of keys and temporarily storing it in the storage buffer, access to the DVD contents or parts of the DVD contents is controlled by pre-commands and post-commands in that the key store is read and the admissibility of the pair of keys is checked upon each playback request.

A further part of the invention is a corresponding data carrier in accordance with the claims.

### BRIEF DESCRIPTION OF DRAWINGS

In detail,

FIG. 1 shows the execution of a payment and playback method “offlinePPV DVD”, where a customer requests one part of the pair of keys from a service centre or support officer (hereinafter called “support centre”),

FIG. 2 shows the navigation layer of a DVD in respect of the method according to the invention, wherein the dummy PGC1 is depicted in several detail layers,

FIG. 3 shows the execution of the playback operation of a DVD.

### DETAILED DESCRIPTION OF EMBODIMENTS

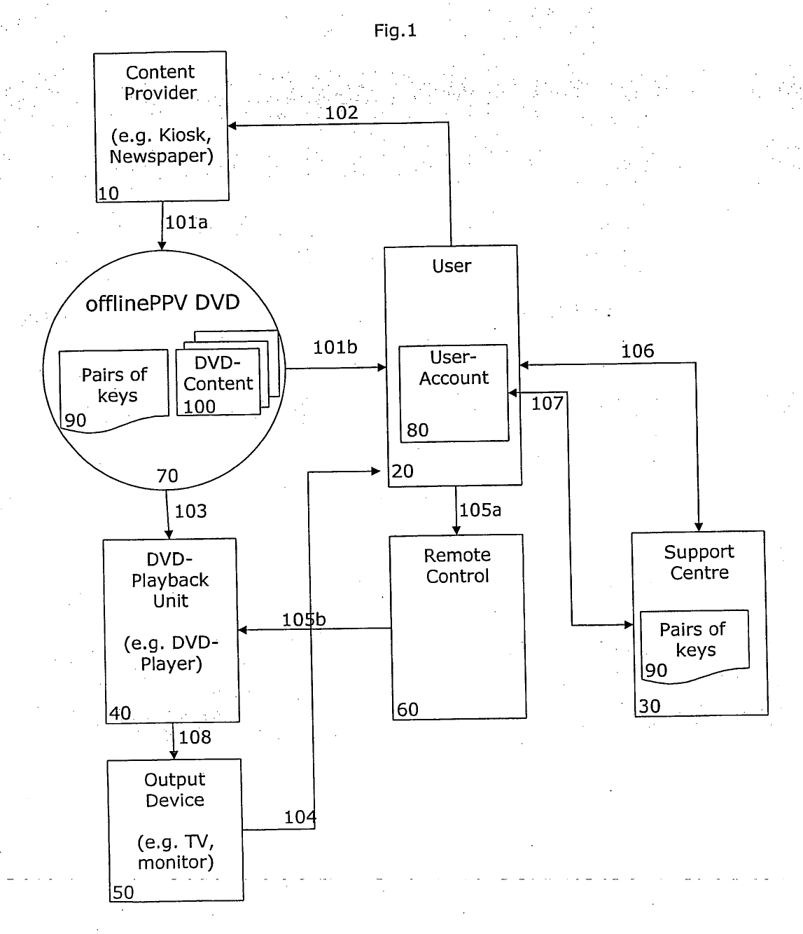

FIG. 1 describes the playback and payment method “offlinePPV DVD”. The content provider 10 distributes 101a)b) e.g. offlinePPV DVDs 70 to users 20 and in turn optionally receives a payment 102. On the offlinePPV DVD is stored a list of pairs of keys 90. The same list is stored in the support centre 30. Optionally the list of pairs of keys may also be an algorithm which is deterministic and which can also be used in the support centre in order to determine the parts of the pair of keys.

The user 20 inserts 103 the offlinePPV DVD 70 into the DVD playback unit 40 and starts the playback function.

The DVD playback device 40 selects a pair of keys from the list of pairs of keys 90 using the random principle and displays one part of the selected pair of keys via the output unit 50 (step 108). Alternatively the pair of keys may be determined by an algorithm. This variant is not illustrated.

The user 20 is prompted 104 to disclose the other part of the pair of keys via the remove control 60 to the DVD playback device 40, see 105a and 105b.

The user 20 obtains the missing part of the pair of keys by making contact with the support centre 30 and requesting 106 the missing part of the pair of keys. The disclosure of the missing part of the pair of keys may be optionally connected with the execution of a payment transaction 107.

After inputting the missing part of the pair of keys 105b, e.g. via the remove control 60, the DVD playback device compares the pair of keys with the pair of keys 90 selected on the offlinePPV DEV 70.

If the details match, i.e. if the correct part of the pair of keys was inputted at the output device 50 via the remote control 60, the DVD playback device will start the playback of the DVD contents 100.

The operation may be repeated any number of times. For each playback operation another part of a pair of keys is selected from the list of pairs of keys 90, for which the user must request the matching other part of the pair of keys from the support centre 30, in order to start the playback operation. This is ensured by a random algorithm which, for instance, may be based on the time of day of the DVD player.

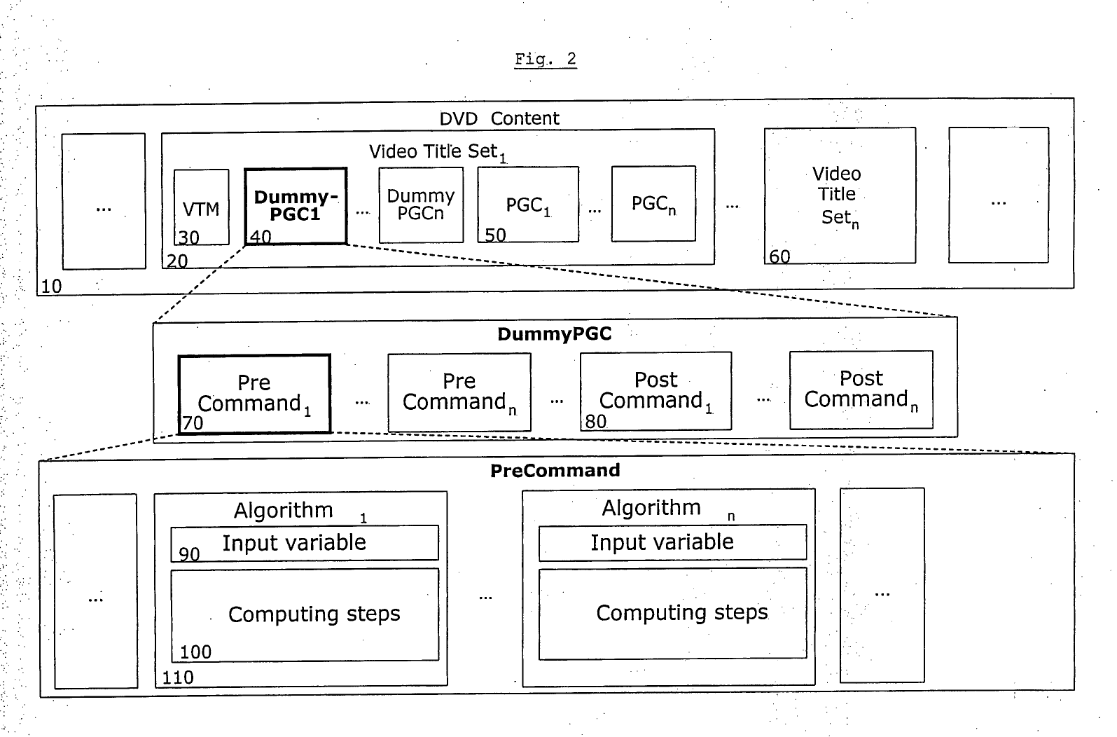

FIG. 2 schematically shows the authoring process, as it is performed during the manufacture of a DVD content.

The authoring process describes steps for preparing DVD playback contents 10 for the offline pay-per-view method. DVD playback contents are logically (navigation layer) summarised to form one or more VideoTitleSets 20. Each VideoTitleSet 20 consists of a defined number of ProgramChains (PGC) 50, in which the playback contents as such are summarised, and DummyPGCs 40. DummyPGCs 40, like PGCs, consist of a pre-command area 70 and a post-command area 80, but, as a rule, not of an area which refers to playback contents. A VideoTitleSet 20 specifies which DummyPGCs 40 and PGCs 50 are called up during a playback operation and in which sequence they are executed.

A DummyPGC 40 consists of a pre-command 70 and a post-command area 80. Each area contains commands which are processed in sequence when the pre-command 70 or post-command 80 area is passed through.

Algorithms 110 for the offline pay-per-view method are stored in the pre-command area 70 for calculating the number keys. Starting from a constant input variable 90 (e.g. the length of a certain VideoTitleSet or a certain PGC or the time of day of the DVD playback device) containing the first key part, the associated key part is calculated over several computing steps 100. The input variable and the computing path are preferably firmly linked to each other for each algorithm 110 and can be correspondingly simulated in the support centre (compare FIG. 1. Illustration of the payment and playback method offlinePPV DVD). Alternatively the algorithm 110 may consist of fixed number pairs, which are accessed via a random variable.

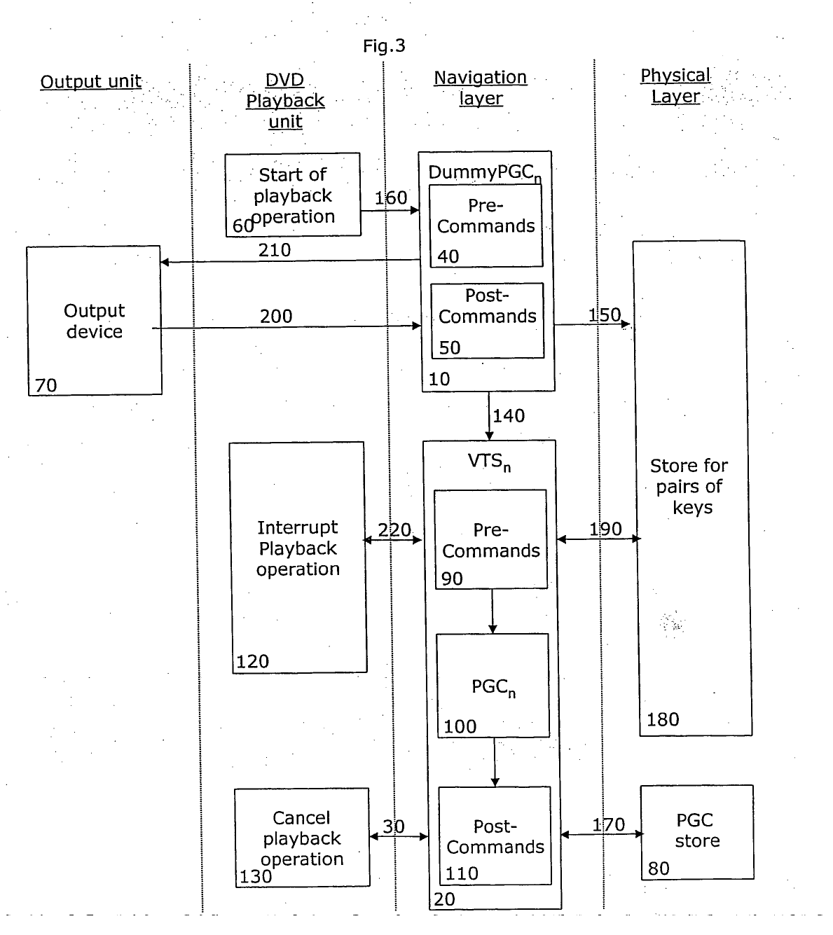

FIG. 3 represents an illustration of the playback operations (navigation). It begins with the start of the playback operation 60. The start of the playback operation causes a DummyPGC 10 to be called. This contains a set of pre-commands 40 and a set of post-commands 50. Part of the pre-commands 40 causes a pair of keys to be selected or calculated according to the algorithm stored for this DummyPGC (compare FIG. 2 _{“}Illustration of the authoring process”).

There follows the output 210 of a part of the pair of keys to the output device 70 and the request for inputting of the associated key part 200.

A part of post-commands 50 compares the input with the calculated second part of the pair of keys. If the inputs match, the valid pair of keys is stored in the key store 180. Then a VideoTitleSet (VTS) 20 or a sequence of VTS 20 is retrieved.

The pre-command area 90 of a VTS 20 inhibits all functions of the DVD controls by default. The control functions are not released until the correct pair of keys has been requested as evidenced by a comparison 190 with the key store 180.

After releasing the control functions the PGC 100 are triggered, on which the DVD contents of the corresponding VideoTitleSets 20 are found.

After passing through the PGC 100 the post-commands 110 are processed. Part of the post-commands stores 170 the information, that the respective PGC was played back, in the PGC store 80.

If the playback operation 120 (e.g. pause, forward, back) is interrupted, the following aspects are considered.

If the playback operation 220 is interrupted, this command is sent to the active VTS 20.

After the interruption the playback operation is resumed at a defined VTS 20. Within the VTS 20 a selected part of the pre-commands 90 checks 190, whether the release of the control functions on the basis of the information deposited in the store is legitimised for the pairs of keys 180.

After releasing the control functions the PGCs 100 containing the DVD contents of the respective VideoTitleSet 20 are activated.

After the post-commands have passed through the PGCs 100 they are processed 110. One of these post-commands stores 170 the information, that the respective PGC 100 was played back, in the PGC store 80.

If the playback operation 130 is cancelled, processing of the then current VTS 20 is aborted. Part of the commands within the post-commands 110 is contained in the information in the PGC store 80 which was the last to be played back completely.

Further details of the structure of DVDs can be found in “An Introduction to DVD March 2003 by Graham Sharpless Disctronics Maufacturing (UK) Ltd” or “DVD Demystified, second Edition, Authoritative Guide to DVD Technology, McGrawHill (ISBN 0-07-135026-8), Universal Disk Format Specification, Revision 2.5, Apr. 30, 2003”.

The preferred embodiments do not represent restrictions, rather the extent of protection shall be determined on the basis of the following claims.

1. A method for safeguarding access to a digital data carrier, on which playback data is provided with pre-commands or post-commands before or after the playback data, comprising the following steps:
a) inputting a key by means of a pre-command or post-command via an input interface,
b) verifying the key by means of a pre-command or post-command, before accessing the playback data; if verification of the key is negative, data playback is cancelled, if verification of the key is positive, data playback proceeds.

2. The method according to claim 1, wherein the key is continually verified by a plurality of pre-commands or post-commands at different points in time.

3. The method according to claim 1, wherein ejection of the data carrier takes place if the key does not match.

4. The method according to claim 1, wherein the key is a pair of keys.

5. The method according to claim 1, wherein the method further comprises the following steps:
random selection of a pair of keys,
display of a first part of the pair of keys together with the request for inputting the second part of the pair of keys, and
verification of the entire key in respect of a match.

6. The method according to claim 5, wherein the pairs of keys or parts of the keys are stored in an encoded manner in a storage area on the data carrier.

7. The method according to claim 5, wherein the pairs of keys are calculated using an algorithm.

8. The method according to claim 1, wherein the read-in key is stored in a storage area or a PGC store for further future verification by a pre-command or post-command.

9. The method according to claim 1, wherein the digital data carrier has been created according to the DVD standard or a standard building on the DVD standard.

10. The method according to claim 5, wherein
the DVD Dummy PGC (Program Chain) contains a set of pre-commands or a set of post-commands for ascertaining a pair of keys,
a part of the pre-commands calculates the pair of keys,
a part of the pre-commands displays one part of the pair of keys on the screen and prompts for input of the second part of the pair of keys,
a part of the post-commands reads-in the second part of the pair of keys on the screen and checks the pair of keys in order to store it in the key store if the two parts match, or to abort the operation if not.

11. The method according to claim 10, wherein access to a PGC is controlled in one or several VTS, using a pre-command or a post-command by reading the key store and checking the admissibility of the pair of keys.

12. A digital data carrier on which the data is integrated with pre-commands or post-commands which data is executed prior to access to the data, wherein a key is verified in at least one pre-command, said key was inputted manually at least once in order to then permit access to the data.

13. The digital data carrier according to claim 12, wherein verification is carried out continually by pre-commands each time a part of the data is played back.

14. The digital data carrier according to claim 12, wherein a plurality of pairs of keys are stored in a storage area, said pairs of keys may be additionally encoded, wherein one of the pre-commands or post-commands is designed in such a way that a pair of keys is selected at random.

15. The digital data carrier according to claim 14, wherein one of the pre-commands or post-commands is designed in such a way that one key of a pair of keys is read-in.

16. The digital data carrier according to claim 15, wherein one of the pre-commands or post-commands is designed in such a way that the key is stored in a storage area or a PGC store.

17. The digital data carrier according to claim 12, wherein the data carrier is a DVD, wherein
a DVD Dummy PGC (program chain) contains a set of pre-commands or a set of post-commands for ascertaining the pair of keys,
a part of the pre-commands displays one part of the pair of keys on the screen and prompts for input of the second part of the pair of keys,
a part of the post-commands reads-in the second part of the pair of keys on the screen and verifies the pair of keys in order to store it in the key store if the two parts match or to abort the operation, if not,
access to a PGC is controlled by a pre-command or a post-command in one or several VTS by reading the key store and checking the admissibility of the pair of keys.
